(19) United States
(12) Patent Application Publication
(10) Pub. No.: US 2022/0198514 A1
(43) Pub. Date: Jun. 23, 2022

(54) INFORMATION PROCESSING APPARATUS, INFORMATION PROCESSING METHOD, AND PROGRAM

(71) Applicant: FELICA NETWORKS, INC., TOKYO (JP)

(72) Inventors: JUN TADA, TOKYO (JP); AKIE TSUNASHIMA, KANAGAWA (JP); MIKI KAKIZAWA, TOKYO (JP)

(21) Appl. No.: 17/593,426

(22) PCT Filed: Mar. 12, 2020
(86) PCT No.: PCT/JP2020/010784

§ 371 Date: Sep. 17, 2021

(30) Foreign Application Priority Data
Mar. 28, 2019 (JP) 2019-062925

(51) Int. Cl. G06Q 30/02; G06Q 20/22

(52) U.S. Cl. CPC G06Q 30/0255; G06Q 20/22; G06Q 30/0201

(57) ABSTRACT

An information processing apparatus of the present technology includes an acquisition unit and a controller. The acquisition unit acquires purchase data regarding a purchase behavior of a user. The controller generates recommendation data for the user to purchase a commodity on the basis of the purchase data.

### TECHNICAL FIELD

The present technology relates to an information processing apparatus, an information processing method, and a program.

### BACKGROUND ART

A technique of recommending various types of information to a user has been recently disclosed as an existing technique of improving the user's willingness to purchase.

For example, Patent Literature 1 describes a technique of presenting to a user advertisements arranged in a priority order based on elements such as an attribute regarding a user, location information, settlement means, and the access history of websites. Further, Patent Literature 2 describes a technique of recommending switching to a credit card to a user who uses a prepaid card.

### CITATION LIST

### Patent Literature

Patent Literature 1: Japanese Patent Application Laid-open No. 2008-250740
Patent Literature 2: Japanese Patent Application Laid-open No. 2016-071657

### DISCLOSURE OF INVENTION

### Technical Problem

A wide variety of return rates that are returned to users when purchasing commodities by point card settlement, credit card settlement, or smartphone settlement have been provided particularly in recent years. Thus, it is difficult for the users to grasp purchasing methods most suitable for themselves among many purchasing methods.

In view of the above circumstances, the present technology recommends a purchasing method most suitable for a user, for example.

### Solution to Problem

In order to solve the above problems, an information processing apparatus according to an embodiment of the present technology includes an acquisition unit and a controller.

The acquisition unit acquires purchase data regarding a purchase behavior of a user.

The controller generates recommendation data for the user to purchase a commodity on the basis of the purchase data.

The information processing apparatus may further include a first database for storing receipt data that is issued when the user purchases a commodity, and the controller may generate the recommendation data on the basis of the purchase data and the receipt data.

The receipt data may include at least one of electronic receipt information, electronic money information, or information regarding a usage history of a credit card.

The information processing apparatus may further include a second database for storing user information regarding the user, and the controller may generate the recommendation data on the basis of the purchase data, the receipt data, and the user information.

The information processing apparatus may further include a third database for storing data in which the purchase data is associated with information regarding a return rate that is a ratio of an amount to be returned to the user to an amount to be paid by the user, and the controller may generate the recommendation data on the basis of the data, the receipt data, and the user information.

The controller may output the purchase data to the third database and updates the third database every time the purchase data is acquired from the acquisition unit.

The purchase data may include at least one of store data, settlement data, point card data, or campaign data.

The controller may determine a combination of the store data, the settlement data, the point card data, and the campaign data in the purchase data with reference to the first database, the second database, and the third databases, and generate the recommendation data on the basis of the combination.

The controller may generate, as the recommendation data, information for prompting the user to use a purchasing method based on the determined combination.

The acquisition unit may acquire an acquisition request for acquiring the recommendation data from the user, and the controller may generate the recommendation data in response to the acquisition request.

The acquisition unit may acquire, as the acquisition request, a request for acquiring the recommendation data corresponding to the commodity, and the controller may determine the combination on the basis of the request.

The acquisition unit may acquire, as the user information, information regarding a preference of the user, and the controller may determine the combination according to a priority based on the preference.

The recommendation data may include information for prompting the user to perform a predetermined operation.

The predetermined operation may include at least one of issuance of a credit card, issuance of a point card, or download of an application.

The information for prompting the user to perform the predetermined operation may be affiliate advertisement information.

In order to solve the above problems, an information processing method for an information processing apparatus according to an embodiment of the present technology includes: acquiring purchase data regarding a purchase behavior of a user; and generating recommendation data for the user to purchase a commodity on the basis of the purchase data.

In order to solve the above problems, a program according to an embodiment of the present technology causes an information processing apparatus to execute the steps of: acquiring purchase data regarding a purchase behavior of a user; and generating recommendation data for the user to purchase a commodity on the basis of the purchase data.

### BRIEF DESCRIPTION OF DRAWINGS

FIG. 1 is a system diagram showing a hardware configuration example of an information processing system according to the present technology.

FIG. 2 is a block diagram showing a hardware configuration example of an information processing apparatus of the information processing system.

FIG. 3 is a block diagram functionally showing a configuration example of the information processing apparatus.

FIG. 4 is a flowchart showing a typical operation flow of the information processing system.

FIG. 5 is a sequence diagram showing details of one step of the operation of the information processing system.

FIG. 6 is a sequence diagram showing details of one step of the operation of the information processing system.

FIG. 7 is a conceptual diagram showing details of the step of generating recommendation data.

FIG. 8 is a sequence diagram showing details of one step of the operation of the information processing system.

FIG. 9 is a conceptual diagram showing details of the step of generating the recommendation data.

FIG. 10 is a conceptual diagram showing details of the step of generating the recommendation data.

FIG. 11 is a sequence diagram showing details of one step of the operation of the information processing system.

FIG. 12 is a diagram showing an example of a pop-up message displayed on a display screen of a smartphone.

### MODE(S) FOR CARRYING OUT THE INVENTION

Hereinafter, an embodiment of the present technology will be described with reference to the drawings.

<Configuration of Information Processing System>

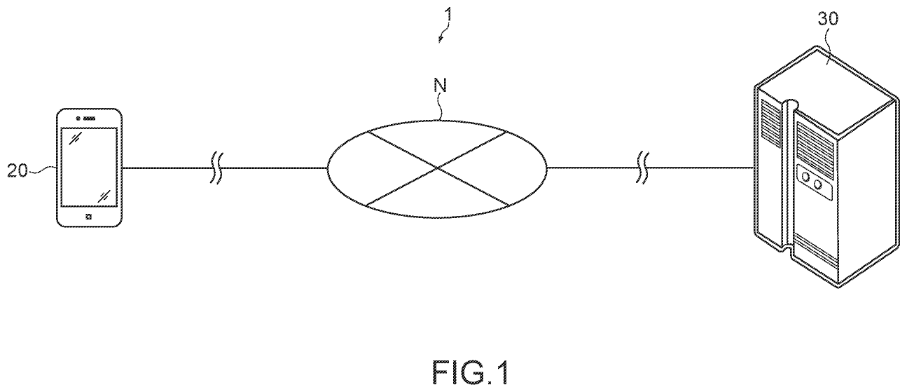

FIG. 1 is a system diagram showing a hardware configuration example of an information processing system 1 according to this embodiment. The information processing system 1 includes a terminal apparatus 20 and an information processing apparatus 30 as shown in FIG. 1. The terminal apparatus 20 and the information processing apparatus 30 are connected to each other so as to be able to communicate with each other via a network N.

[Terminal Apparatus]

The terminal apparatus 20 is an apparatus capable of executing any application. Although the specific operation of the terminal apparatus 20 will be described later, when a user executes any application, the terminal apparatus 20 registers, in the information processing apparatus 30, a function to be provided to the terminal apparatus 20 by the information processing apparatus 30 or changes the function registered in the information processing apparatus 30.

The terminal apparatus 20 is, for example, a mobile terminal, a wearable device, or a personal computer (PC), and is typically a mobile terminal.

The mobile terminal is, for example, a smart phone, a mobile phone terminal, a tablet terminal, or the like. The wearable device is, for example, a head mounted display (HMD), smart eye glasses, or the like.

[Information Processing Apparatus]

It is a server that generates recommendation data for recommending a purchasing method suitable for the user on the basis of purchase data regarding a purchase behavior of the user, which is acquired via the terminal apparatus 20. The information processing apparatus 30 of this embodiment is typically a web server, but is not limited thereto. For example, any other computer such as a PC may be used.

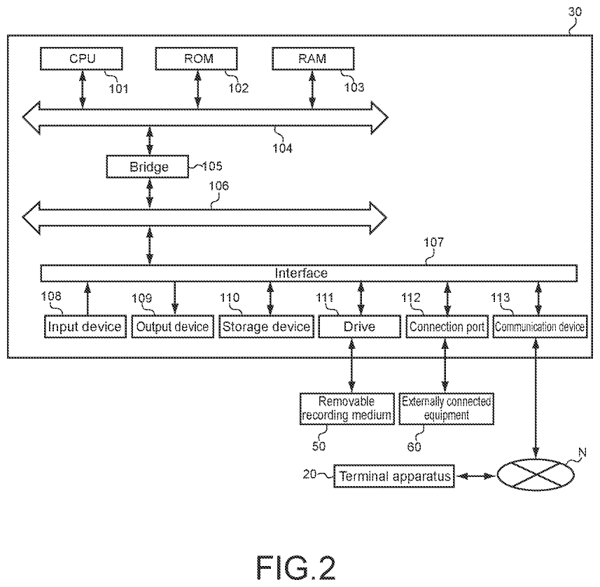

FIG. 2 is a block diagram showing an example of a hardware configuration of the information processing apparatus 30. The information processing apparatus 30 includes a central processing unit (CPU) 101, a read only memory (ROM) 102, and a random access memory (RAM) 103.

Further, the information processing apparatus 30 may include a host bus 104, a bridge 105, an external bus 106, an interface 107, an input device 108, an output device 109, a storage device 110, a drive 111, a connection port 112, and a communication device 113.

Furthermore, the information processing apparatus 30 may include a processing circuit such as a digital signal processor (DSP), an application specific integrated circuit (ASIC), or a field-programmable gate array (FPGA) instead of or together with the CPU 101.

The CPU 101 functions as an arithmetic processing unit and a controller, and controls the overall operation of the information processing apparatus 30 or part thereof according to various programs (hereinafter referred to as “recommendation programs”) recorded in the ROM 102, the RAM 103, the storage device 110, or on a removable recording medium 50.

The ROM 102 stores the recommendation programs, calculation parameters, and the like to be used by the CPU 101. The RAM 103 temporarily stores the recommendation programs to be used in the execution of the CPU 101, parameters that appropriately change in the execution of the recommendation programs, and the like.

The CPU 101, the ROM 102, and the RAM 103 are interconnected by a host bus 104 including an internal bus such as a CPU bus. In addition, the host bus 104 is connected via a bridge 105 to an external bus 106 such as a peripheral component interconnect/interface (PCI) bus.

The input device 108 is a device operated by a user, such as a mouse, a keyboard, a touch panel, a button, a switch, or a lever. The input device 108 may be, for example, a remote control device using infrared rays or other radio waves, or may be externally connected equipment 60 such as a mobile phone corresponding to the operation of the information processing apparatus 30.

The input device 108 includes input control circuits for generating input signals on the basis of information input by the user and outputting the generated input signals to the CPU 101. By operating the input device 108, the user inputs various types of data to the information processing apparatus 30 or instructs processing operations.

The output device 109 is configured by a device capable of notifying the user of the acquired information by using senses such as a sense of vision, a sense of hearing, and a sense of touch. The output device 109 may be, for example, a display device such as a liquid crystal display (LCD) or an organic electro-luminescence (EL) display, a sound output device such as a speaker or headphones, or a vibrator. The output device 109 outputs the result acquired by the processing of the information processing apparatus 30 as a video such as a text or an image, a sound such as voice or audio, or vibration.

The storage device 110 is a data storage device configured as an example of a storage unit of the information processing apparatus 30. The storage device 110 is configured by, for example, a magnetic storage device such as a hard disk drive (HDD), a semiconductor storage device, an optical storage device, or a magneto-optical storage device. The storage device 110 stores, for example, recommendation programs to be executed by the CPU 101, various types of data, and various types of data acquired from the outside.

The drive 111 is a reader/writer for the removable recording medium 50 such as a magnetic disk, an optical disc, a magneto-optical disk, or a semiconductor memory, and is built in or externally attached to the information processing apparatus 30. The drive 111 reads the information recorded on the removable recording medium 50 mounted thereon, and outputs the read information to the RAM 103. Further, the drive 111 writes a record on the removable recording medium 50 mounted thereon.

The connection port 112 is a port for connecting a device to the information processing apparatus 30. The connection port 112 may be, for example, a universal serial bus (USB) port, an IEEE1394 port, or a small computer system interface (SCSI) port. Further, the connection port 112 may be an RS-232C port, an optical audio terminal, a high-definition multimedia interface (HDMI) (registered trademark) port, or the like. The externally connected equipment 60 is connected to the connection port 112, and thus various types of data can be exchanged between the information processing apparatus 30 and the externally connected equipment 60.

The communication device 113 is, for example, a communication interface including a communication device for connecting to the network N, or the like. The communication device 113 may be, for example, a communication card for a local area network (LAN), Bluetooth (registered trademark), Wi-Fi, or wireless USB (WUSB).

Further, the communication device 113 may be a router for optical communication, a router for asymmetric digital subscriber line (ADSL), or modems for various types of communication. The communication device 113 transmits and receives signals and the like to and from the Internet or other communication devices by using a predetermined protocol such as TCP/IP.

Furthermore, the network N connected to the communication device 113 is a network connected in a wired or wireless manner and may include, for example, the Internet, a home LAN, infrared communication, radio wave communication, and satellite communication.

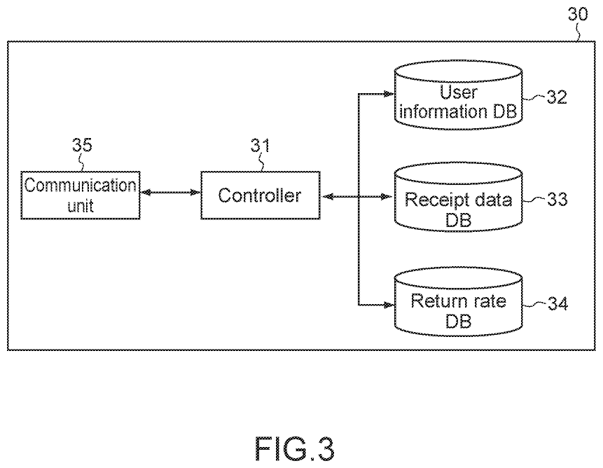

FIG. 3 is a block diagram functionally showing a configuration example of the information processing apparatus 30. As shown in FIG. 3, the information processing apparatus 30 includes a controller 31, a user information DB 32, a receipt data DB 33, a return rate DB 34, and a communication unit 35. Note that the above-mentioned “DB” means a database, and the same applies to the following description.

The controller 31 controls the entire operation of the information processing apparatus 30 or part thereof. The controller 31 may be the CPU 101. The user information DB 32 stores user information regarding a user who handles the terminal apparatus 20. The user information is output to the user information DB 32 via the terminal apparatus 20.

The user information DB 32 is an example of a “second database” in Claims. The user information DB 32 may be stored in the ROM 102, the RAM 103, the storage device 110, or on the removable recording medium 50.

Here, the user information is, for example, at least one of information regarding the user's age, sex, occupation, annual income, whether or not the user is married, whether or not the user has a child, the type of a credit card held, the type of electronic money held, the type of a point card held, the terminal apparatus 20 held (for example, the model of the terminal apparatus 20, the OS, the mobile phone company, applications, etc.), the preference of the user, or feedback from the user to the recommendation. The same applies to the following description.

The receipt data DB 33 stores receipt data that is issued when the user purchases a commodity. As a result, a business operator who manages the information processing apparatus 30 can grasp the purchase behavior and habits of the user, e.g., in which store, what settlement means and what point card the user has used, and what commodity the user has purchased. In addition, the business operator can also grasp the purchase tendency of the user, such as the use frequency of the store and the settlement method.

The receipt data is, for example, registered in the receipt data DB 33 via the terminal apparatus 20 that has read the information described on the receipt of the paper medium.

The receipt data DB 33 is an example of a “first database” in Claims. The receipt data DB 33 may be stored in the ROM 102, the RAM 103, the storage device 110, or on the removable recording medium 50.

The receipt data is, for example, at least one of information regarding a user's commodity purchase date and time, a store at which the commodity has been purchased (for example, a business condition of the store, a chain name, a branch name, an address, etc.), a purchased commodity (for example, a commodity name, a Japanese article number (JAN) code, a unit price, number of pieces, etc.), a discount amount at the time of purchase of the commodity, a total amount at the time of purchase of the commodity, a settlement method (cash settlement, credit card settlement, electronic money settlement, point settlement, gift ticket settlement, etc.), or a point card (type of the point card, the number of points held, the number of points granted at the time of purchase of the commodity, etc.). The same applies to the following description.

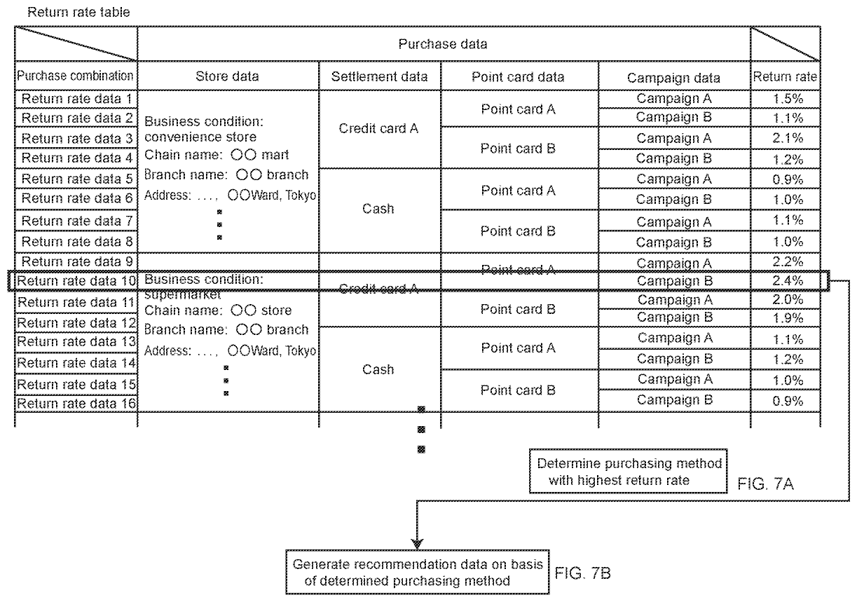

The return rate DB 34 stores data (hereinafter, referred to as return rate data) in which purchase data regarding the user's purchase behavior and information regarding the return rate are associated with each other. The return rate data means a purchasing method that a user can take when purchasing a commodity. The return rate DB 34 of this embodiment stores a return rate table including a plurality of pieces of return rate data (see FIG. 7). This provides a quantitative list of the return rate data for each store at which the purchase is performed. Note that the numerical values of the return rate in the return rate tables of FIGS. 7, 9, and 10 are merely examples, and the return rate of this embodiment is not limited to those numerical values as a matter of course.

The return rate DB 34 is an example of a “third database” in Claims. The return rate DB 34 may be stored in the ROM 102, the RAM 103, the storage device 110, or on the removable recording medium 50.

The purchase data includes, for example, at least one of store data, settlement data, point card data, or campaign data (see FIG. 7).

Here, the store data is, for example, information regarding a store that a user can enter, and includes at least one of information regarding a business condition, a chain name, a branch name, or an address of the store.

The settlement data is information regarding a settlement method that a user can take when purchasing a commodity. Examples of such a settlement method include cash settlement, credit card settlement, and electronic money settlement.

The point card data is information regarding a point card that a user can present when purchasing a commodity. Examples of such a point card include various common point cards (e.g., a T-point (registered trademark) card, a d-point card (registered trademark), a Ponta (registered trademark) card, and the like), and store-limited cards (e.g., a Bic Camera POINTCARD (registered trademark)).

The campaign data is information regarding a campaign being held when a user purchases a commodity (for example, campaign held at a store where the user can enter). Such a campaign imposes various conditions for returning the amount (limited period, limited settlement method, limited ages, and minimum purchase amount, and the like) on the user who purchases the commodity.

Further, the above-mentioned return rate is a ratio of the total amount to be returned to the user to the amount to be paid by the user at the time of purchasing the commodity. For example, when the store data stored in the return rate DB 34 has A types, the settlement data has B types, the point card data has C types, and the campaign data has D types, the combinations of the return rate data are A×B×C×D types. The return rate DB 34 of this embodiment calculates and stores the return rate for each pieces of the return rate data of the A×B×C×D ways.

In this case, for example, the return rate data 5 shown in FIG. 7 means a purchasing method in which the user performs cash settlement using a point card A, with which Y % is returned in an A mart, during a campaign A period in which X % is returned. Thus, when the amount to be paid by the user is Z yen, the return rate is calculated by, for example, the following equation (1).

Return rate (%)=[{(Z×(X/100))+(Z×(Y/100))}/Z]×100 (1)

Note that the definition of the store data, the settlement data, the point card data, and the campaign data described above is the same as in the following description.

The communication unit 35 communicates with external devices such as the terminal apparatus 20 and the information processing apparatus 30 via the network N. The communication unit 35 functions as a communication interface of the information processing apparatus 30. The communication unit 35 is an example of an “acquisition unit” in Claims. The communication unit 35 may be the communication device 113.

An example of the configuration of the information processing system 1 has been described above. Each of the above-mentioned components may be configured by using a general-purpose member or may be configured by a member specialized for the function of each component. Such a configuration may be changed as appropriate according to the technical level at the time of implementation.

<Operation of Information Processing System>

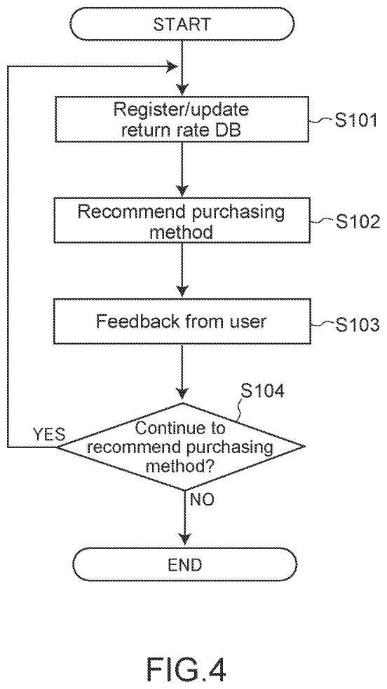

FIG. 4 is a flowchart showing a typical operation flow of the information processing system 1. Hereinafter, the operation of the information processing system 1 will be described with reference to FIG. 4 as appropriate.

[Step S101: Registration/Update of Return Rate DB]

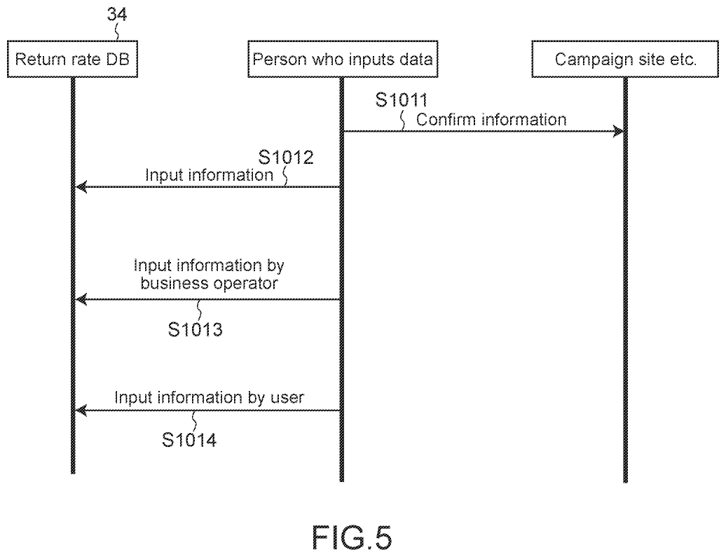

FIG. 5 is a sequence diagram showing details of Step S101. The user accesses an external server (not shown) that provides a website, in which campaign data is described, through the terminal apparatus 20. Thus, the website is displayed in the browser application executed by the terminal apparatus 20 (Step S1011).

The user outputs the campaign data obtained by accessing the external server (not shown), and the purchase data including the store data, the settlement data, and the point card data to the communication unit 35 by using the terminal apparatus 20. The communication unit 35 registers the purchase data acquired from the terminal apparatus 20 in the return rate DB 34 (Step S1012).

Next, a business operator who wants to disclose the stores developed by the company of the business operator, the settlement method, the point card, and the campaign outputs the purchase data including the store data, settlement data, point card data, and campaign data regarding the above data to the communication unit 35 by using the terminal apparatus 20. The communication unit 35 registers the purchase data acquired from the terminal apparatus 20 in the return rate DB 34 (Step S1013).

Next, the user outputs the purchase data including store data, settlement data, point card data, and campaign data obtained by any method, such as commercial messages on the television or advertisements in magazines, to the communication unit 35 by using the terminal apparatus 20. The communication unit 35 registers the purchase data acquired from the terminal apparatus 20 in the return rate DB 34 (Step S1014).

[Step S102: Recommendation of Purchasing Method]

### Application Example 1

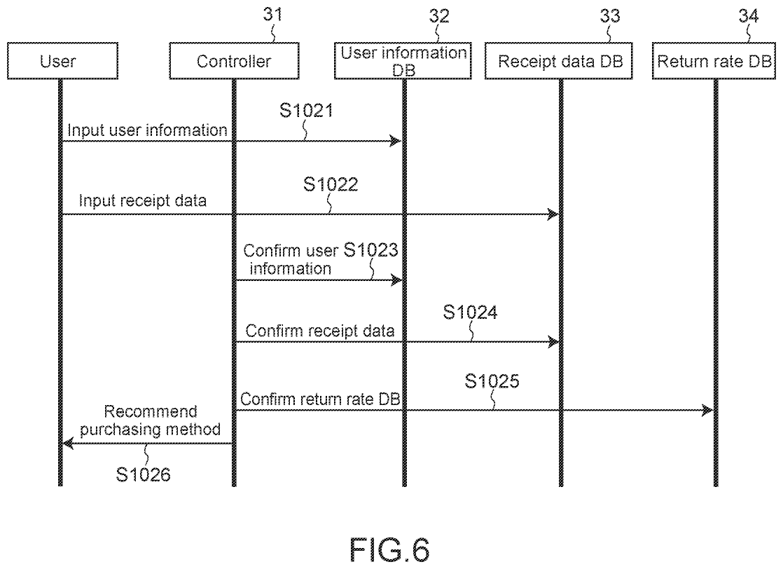

FIG. 6 is a sequence showing details of Step S102 in Application Example 1. The user registers the user information in the user information DB 32 through the terminal apparatus 20 (Step S1021).

The user then runs the application installed on the terminal apparatus 20. The terminal apparatus 20 reads the receipt data described on the receipt, which is issued at the time of user's purchase of the commodity, through the application. The terminal apparatus 20 registers the read receipt data in the receipt data DB 33 (Step S1022).

Subsequently, the controller 31 refers to the user information DB 32, the receipt data DB 33, and the return rate DB 34 (Steps S1023 to S1025), generates recommendation data on the basis of the user information, the receipt data, and the return rate data registered in those DBs, and outputs the recommendation data to the terminal apparatus 20 (Step S1026). As a result, the user can grasp a purchasing method that is determined to be advantageous on the basis of the usual purchase behaviors of the user (a store where the user goes, a settlement method, etc.) among various existing purchasing methods.

### Specific Example of Application Example 1

FIG. 7 is a conceptual diagram showing details of a process of generating recommendation data in Application Example 1. Specifically, for example, the controller 31 determines the return rate data having the highest return rate from the combinations (return rate table) of the return rate data including the store data, the settlement data, the point card data, and the campaign data stored in the return rate DB 34 (FIG. 7a).

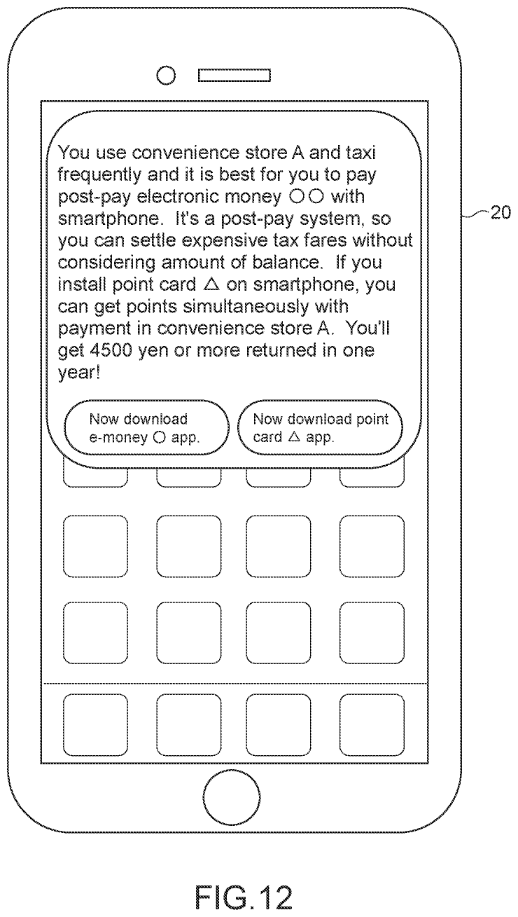

The controller 31 then generates recommendation data on the basis of the determined return rate data, the user information, and the receipt data (FIG. 7b), and outputs the recommendation data to the terminal apparatus 20. The terminal apparatus 20 displays the recommendation data acquired from the information processing apparatus 30 as information for prompting the user to use a purchasing method based on the return rate data previously determined (see FIG. 7a) (see FIG. 12). Thus, the user can quantitatively grasp the purchasing method having the greatest economic merit for the user by confirming the recommendation data displayed on the terminal apparatus 20.

### Application Example 2

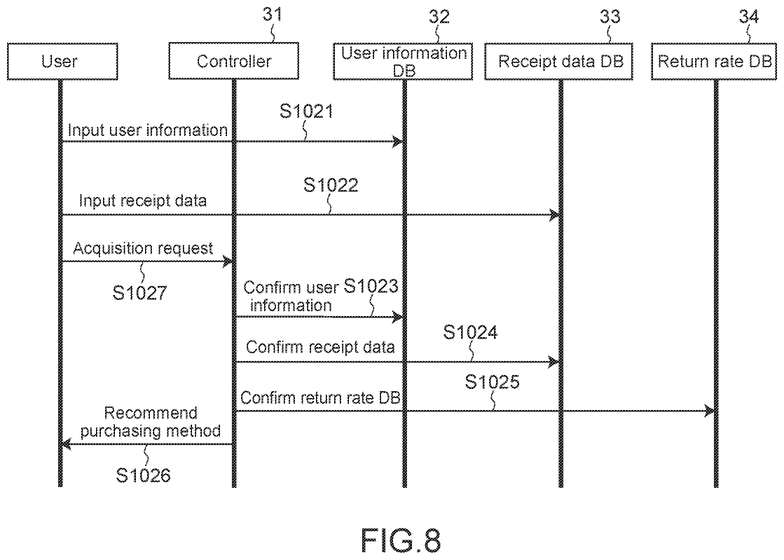

FIG. 8 is a sequence diagram showing details of Step S102 in Application Example 2. Note that in Application Example 2 the same steps as those in Application Example 1 are denoted by the same reference numerals, and the description thereof will be omitted or simplified.

The user outputs an acquisition request for acquiring recommendation data to the communication unit 35 by using the terminal apparatus 20 (Step S1027). In response to the acquisition of the acquisition request from the communication unit 35, the controller 31 executes Steps S1023 to S1026. As a result, the user can obtain recommendation data anywhere at a desired timing.

### Specific Example 1 of Application Example 2

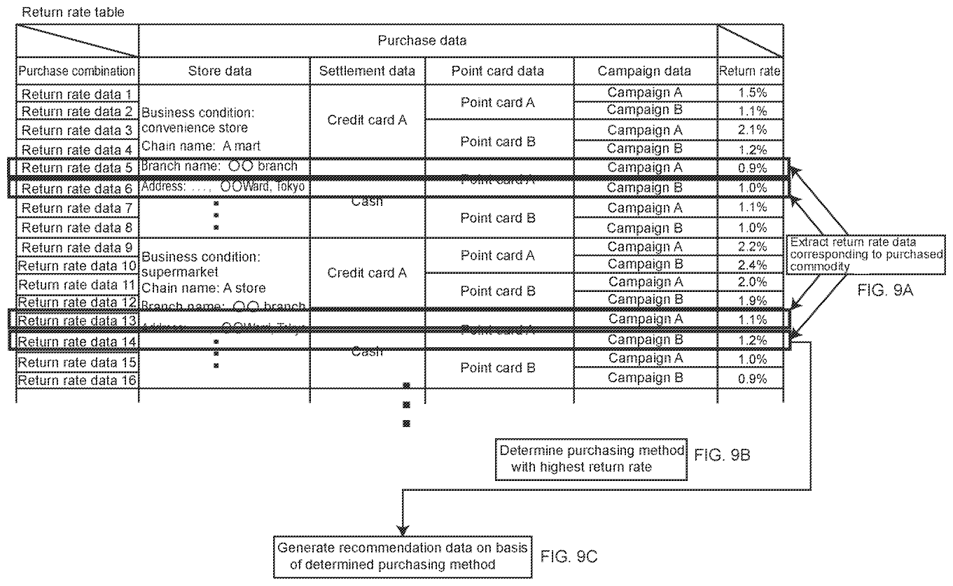

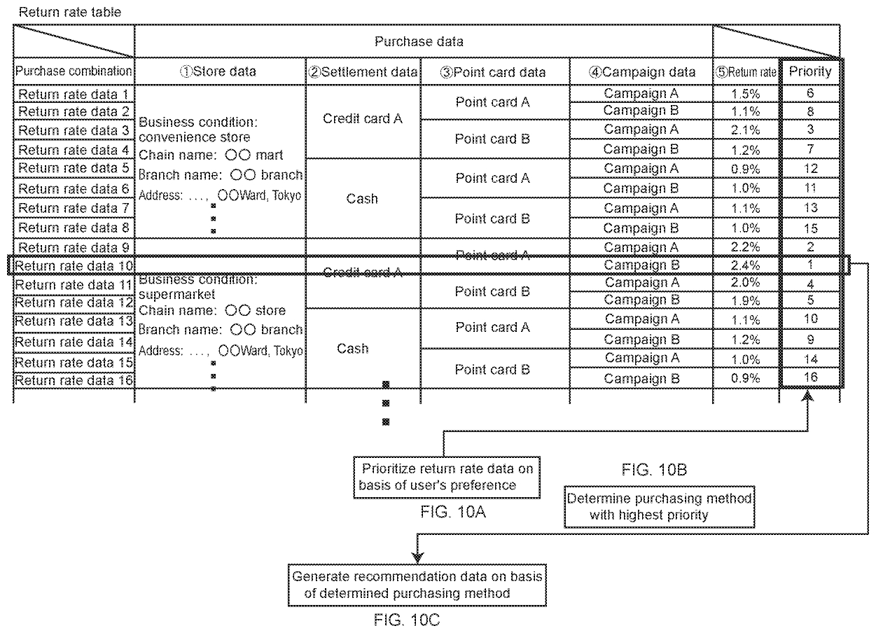

FIGS. 9 and 10 are conceptual diagrams showing details of a process of generating recommendation data in Application Example 2. Specifically, the user outputs an acquisition request for acquiring recommendation data corresponding to a commodity to be purchased to the communication unit 35 by using the terminal apparatus 20 (Step S1027).

In response to the acquisition of the acquisition request from the communication unit 35, the controller 31 acquires information regarding the purchased commodity as receipt data registered in the receipt data DB 33. The controller 31 generates recommendation data on the basis of the information regarding the purchased commodity, the return rate data, and the user information.

More specifically, for example, the controller 31 extracts, from the return rate table, a purchasing method (return rate data) that the user can execute when purchasing a commodity, on the basis of the information regarding the purchased commodity acquired from the receipt data DB 33 and the user information (FIG. 9a). The controller 31 then selects the return rate data having the highest return rate from the extracted return rate data (FIG. 9b), and generates recommendation data on the basis of the selected return rate data (FIG. 9c). Thus, the user can grasp the purchasing method having the greatest economic merit among the purchasing methods that the user can execute when purchasing a commodity.

### Specific Example 2 of Application Example 2

Alternatively, the user outputs an acquisition request for acquiring recommendation data to the communication unit 35 by using the terminal apparatus 20 (Step S1027). In response to the acquisition of the acquisition request from the communication unit 35, the controller 31 acquires information regarding a user's preference registered in the user information DB 32.

Note that the “user's preference” described above means a degree of importance in the user's ordinary purchase behavior (emphasis on a return rate, emphasis on credit card settlement, and the like) set by the user. Information regarding the user's preference is input to the terminal apparatus 20 by the user and registered as user information in the user information DB 32.

Next, the controller 31 generates recommendation data on the basis of the information regarding the user's preference acquired from the user information DB 32, the receipt data, and the return rate data.

More specifically, for example, the controller 31 prioritizes each of the plurality of pieces of return rate data stored in the return rate DB 34 on the basis of the information regarding the user's preference and the receipt data (FIG. 10a). The controller 31 then selects the return rate data having the highest order from the plurality of pieces of return rate data according to the priority (FIG. 10b), and generates recommendation data on the basis of the selected return rate data (FIG. 10c). Thus, the user can grasp the purchasing method that meets most the user's preference.

Note that the method of generating recommendation data described in the above Step S102 is merely an example, and of course the present technology is not limited to this method.

[Step S103: Feedback from User]

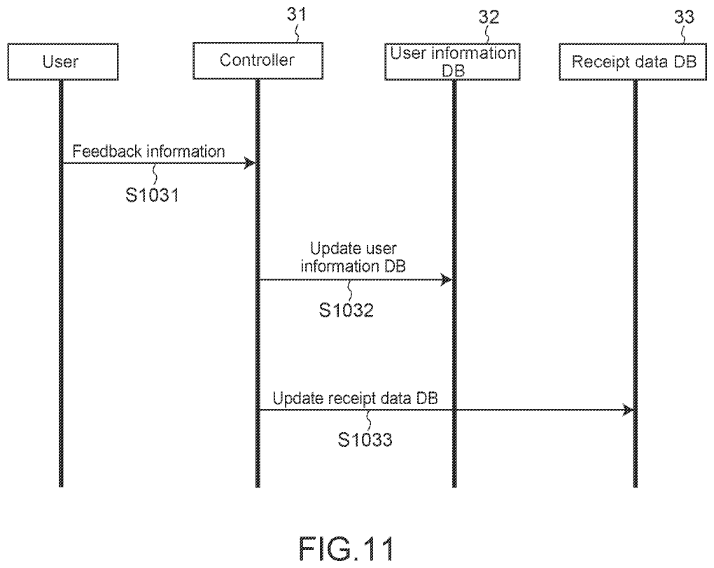

FIG. 11 is a sequence diagram showing details of Step S103. The user confirms the recommendation data displayed on the terminal apparatus 20, and outputs feedback information for the recommendation data to the controller 31 via the terminal apparatus 20 (Step S1031).

In response to the acquisition of the feedback information from the terminal apparatus 20, the controller 31 updates the user information registered in the user information DB 32 and the receipt data registered in the receipt data DB 33 (Steps S1032 and S1033).

Specifically, for example, when the user newly issues a point card in accordance with the recommendation data displayed on the terminal apparatus 20, the controller 31 receives feedback from the user, which is the issuance of the point card, and updates the information regarding the type of the held point card, which is the user information, and the information regarding the point card, which is the receipt data.

[Step S104: Continue to Recommend Purchasing Method?]

When the information processing apparatus 30 continues to recommend the purchasing method to the user (YES in Step S104), the previous Step S101 is repeatedly executed. At that time, all of Steps S1011 to S1014 or one or two of Steps S1012, S1013, and S1014 are repeatedly executed.

As a result, the controller 31 outputs the purchase data to the return rate DB 34 every time the purchase data (store data, settlement data, point card data, and campaign data) is acquired from the communication unit 35. Thus, the return rate DB 34 (return rate table) is updated and constantly kept up to date.

In addition, in the process of repeatedly executing Steps S101 to S103, the previous Steps S102 and S103 are also repeatedly executed. At that time, the user information DB 32 and the receipt data DB 33 are updated by repeatedly executing Steps S1021, S1022, S1032, and S1033, and are constantly kept up to date.

In this embodiment, Steps S101 to S103 are repeatedly executed, and the user information DB 32, the receipt data DB 33, and the return rate DB 34 are constantly updated to be kept up to date, so that the recommendation data more suitable for the purchase behavior and preference of the user is provided to the user in Step S1026.

<Use Case>

Next, an example of a specific use case of the information processing system 1 will be described with reference to FIG. 4 as appropriate.

[Step S102: Recommendation of Purchasing Method]

The user runs an application installed on a smartphone (terminal apparatus 20), inputs the user's personal information (age: 30s, sex: man, annual income: 8 million yen, place of residence: Tokyo, presence/absence of spouse: absence, possible settlement method: credit card settlement, electronic money settlement, mobile settlement) to the input screen of the smartphone displayed by the application, and registers the information (user information) in the user information DB 32 (Step S1021).

Next, the user uses the application installed on the smartphone to read the receipt data (purchase time zone: morning, purchased commodities: coffee and food, settlement method: transportation electronic money settlement) described on the paper receipt issued at the time of purchasing the commodities at a convenience store A, and the receipt data (use time zone: night, settlement method: credit card settlement) described on the paper receipt issued when using a taxi, and registers those pieces of receipt data in the receipt data DB 33 (Step S1022).

Subsequently, the information processing apparatus 30 (controller 31) refers to the user information DB 32, the receipt data DB 33, and the return rate DB 34 in accordance with the recommendation program (Steps S1023, S1024, S1025), and recommends an optimal purchasing method to the user via the smartphone (Step S1026).

Here, since the user does not present a point card when purchasing the commodities at the convenience store A and executes the credit card settlement that requires a signature when using the taxi, the information processing apparatus 30 (controller 31) transmits a pop-up for recommending the electronic money settlement, in which a point card is presented, to the smartphone in consideration of those purchase behaviors. As a result, the display screen of the smartphone displays a pop-up message (recommendation data) as shown in FIG. 12. This allows the user to quantitatively grasp how much economic benefit the user will have in the future if the user agrees to the recommended purchasing method.

Note that, as shown in FIG. 12, the pop-up message includes an icon that is an affiliate advertisement for prompting the user to download an electronic money application and a point card application. The icon is an example of “information for prompting the user to perform a predetermined operation” in Claims. FIG. 12 is a diagram showing an example of a pop-up message displayed on the display screen of the smartphone.

[Step S103: Feedback from User]

If the user understands the recommendation contents of the pop-up message, the user taps the icons displayed on the smartphone, downloads the electronic money application and the point card application, and installs those applications on the smartphone (Step S1031). Thus, a service provider who provides the electronic money and point card applications pays the success fee to the business operator who manages the information processing apparatus 30.

Therefore, according to the present technology, it is possible to develop a business in which the business operator who manages the information processing apparatus 30 has an opportunity to obtain a remuneration from a service provider who provides an application by prompting the user to use the application, and the service provider can quantitatively advertise the provider's service to a potential user who has not yet used the service, and both of them have advantages.

<Modifications>

Although the embodiment of the present technology has been described above, the present technology is not limited to the embodiment described above, and of course various modifications may be made thereto.

For example, in the above embodiment, when the recommendation data is generated, the information described on the receipt of the paper medium is used as the receipt data, but the present technology is not limited thereto. For example, at least one of electronic receipt information, electronic money information, or information regarding a usage history of a credit card may be used.

Further, in the use case of the embodiment described above, the pop-up message includes an icon for prompting the user to download the electronic money application and the point card application, but the present technology is not limited thereto, and may include, for example, an icon for prompting the user to issue a credit card or point card.

<Supplement>

The embodiment of the present technology may include, for example, an information processing apparatus as described above, an information processing system, an operation executed by the information processing apparatus or the information processing system, a program for causing the information processing apparatus to function, and a non-transitory, tangible medium on which the program is recorded.

Further, although the information processing system 1 of this embodiment has been described on the assumption that a purchasing method is recommended to the user, the present technology is not limited thereto. The application of the present technology is not particularly limited.

In addition, the effects described herein are illustrative or exemplary only and not restrictive. In other words, the present technology may provide other effects apparent to those skilled in the art from the description herein, in addition to or instead of the effects described above.

Although the suitable embodiment of the present technology has been described in detail above with reference to the accompanying drawings, the present technology is not limited to such an example. It is clear that persons who have common knowledge in the technical field of the present technology could conceive various alterations or modifications within the scope of the technical idea described in the Claims. It is understood that of course such alterations or modifications also fall under the technical scope of the present technology.

Note that the present technology can have the following configurations.

(1) An information processing apparatus, including

an acquisition unit that acquires purchase data regarding a purchase behavior of a user; and

a controller that generates recommendation data for the user to purchase a commodity on the basis of the purchase data.

(2) The information processing apparatus according to (1), further including

a first database for storing receipt data that is issued when the user purchases a commodity, in which

the controller generates the recommendation data on the basis of the purchase data and the receipt data.

(3) The information processing apparatus according to (2), in which

the receipt data includes at least one of electronic receipt information, electronic money information, or information regarding a usage history of a credit card.

(4) The information processing apparatus according to (2) or (3), further including

a second database for storing user information regarding the user, in which

the controller generates the recommendation data on the basis of the purchase data, the receipt data, and the user information.

(5) The information processing apparatus according to (4), further including

a third database for storing data in which the purchase data is associated with information regarding a return rate that is a ratio of an amount to be returned to the user to an amount to be paid by the user, in which

the controller generates the recommendation data on the basis of the data, the receipt data, and the user information.

(6) The information processing apparatus according to (5), in which

the controller outputs the purchase data to the third database and updates the third database every time the purchase data is acquired from the acquisition unit.

(7) The information processing apparatus according to (5) or (6), in which

the purchase data includes at least one of store data, settlement data, point card data, or campaign data.

(8) The information processing apparatus according to (7), in which

the controller determines a combination of the store data, the settlement data, the point card data, and the campaign data in the purchase data with reference to the first database, the second database, and the third databases, and generates the recommendation data on the basis of the combination.

(9) The information processing apparatus according to (8), in which

the controller generates, as the recommendation data, information for prompting the user to use a purchasing method based on the determined combination.

(10) The information processing apparatus according to (8) or (9), in which

the acquisition unit acquires an acquisition request for acquiring the recommendation data from the user, and

the controller generates the recommendation data in response to the acquisition request.

(11) The information processing apparatus according to (10), in which

the acquisition unit acquires, as the acquisition request, a request for acquiring the recommendation data corresponding to the commodity, and

the controller determines the combination on the basis of the request.

(12) The information processing apparatus according to any one of (8) to (11), in which

the acquisition unit acquires, as the user information, information regarding a preference of the user, and

the controller determines the combination according to a priority based on the preference.

(13) The information processing apparatus according to any one of (1) to (12), in which

the recommendation data includes information for prompting the user to perform a predetermined operation.

(14) The information processing apparatus according to (13), in which

the predetermined operation includes at least one of issuance of a credit card, issuance of a point card, or download of an application.

(15) The information processing apparatus according to (13) or (14), in which

the information for prompting the user to perform the predetermined operation is affiliate advertisement information.

(16) An information processing method, including:

by an information processing apparatus,

acquiring purchase data regarding a purchase behavior of a user; and

generating recommendation data for the user to purchase a commodity on the basis of the purchase data.

(17) A program causing an information processing apparatus to execute the steps of:

acquiring purchase data regarding a purchase behavior of a user; and

generating recommendation data for the user to purchase a commodity on the basis of the purchase data.

### REFERENCE SIGNS LIST

information processing system 1
terminal apparatus 20
information processing apparatus 30
controller 31
user information DB 32
receipt data DB 33
return rate DB 34
communication unit 35

1. An information processing apparatus, comprising
an acquisition unit that acquires purchase data regarding a purchase behavior of a user; and
a controller that generates recommendation data for the user to purchase a commodity on a basis of the purchase data.

2. The information processing apparatus according to claim 1, further comprising
a first database for storing receipt data that is issued when the user purchases a commodity, wherein
the controller generates the recommendation data on a basis of the purchase data and the receipt data.

3. The information processing apparatus according to claim 2, wherein
the receipt data includes at least one of electronic receipt information, electronic money information, or information regarding a usage history of a credit card.

4. The information processing apparatus according to claim 2, further comprising
a second database for storing user information regarding the user, wherein
the controller generates the recommendation data on a basis of the purchase data, the receipt data, and the user information.

5. The information processing apparatus according to claim 4, further comprising
a third database for storing data in which the purchase data is associated with information regarding a return rate that is a ratio of an amount to be returned to the user to an amount to be paid by the user, wherein
the controller generates the recommendation data on a basis of the data, the receipt data, and the user information.

6. The information processing apparatus according to claim 5, wherein
the controller outputs the purchase data to the third database and updates the third database every time the purchase data is acquired from the acquisition unit.

7. The information processing apparatus according to claim 5, wherein
the purchase data includes at least one of store data, settlement data, point card data, or campaign data.

8. The information processing apparatus according to claim 7, wherein
the controller determines a combination of the store data, the settlement data, the point card data, and the campaign data in the purchase data with reference to the first database, the second database, and the third databases, and generates the recommendation data on a basis of the combination.

9. The information processing apparatus according to claim 8, wherein
the controller generates, as the recommendation data, information for prompting the user to use a purchasing method based on the determined combination.

10. The information processing apparatus according to claim 8, wherein
the acquisition unit acquires an acquisition request for acquiring the recommendation data from the user, and
the controller generates the recommendation data in response to the acquisition request.

11. The information processing apparatus according to claim 10, wherein
the acquisition unit acquires, as the acquisition request, a request for acquiring the recommendation data corresponding to the commodity, and
the controller determines the combination on a basis of the request.

12. The information processing apparatus according to claim 8, wherein
the acquisition unit acquires, as the user information, information regarding a preference of the user, and
the controller determines the combination according to a priority based on the preference.

13. The information processing apparatus according to claim 1, wherein
the recommendation data includes information for prompting the user to perform a predetermined operation.

14. The information processing apparatus according to claim 13, wherein
the predetermined operation includes at least one of issuance of a credit card, issuance of a point card, or download of an application.

15. The information processing apparatus according to claim 13, wherein
the information for prompting the user to perform the predetermined operation is affiliate advertisement information.

16. An information processing method, comprising:
by an information processing apparatus,
acquiring purchase data regarding a purchase behavior of a user; and
generating recommendation data for the user to purchase a commodity on a basis of the purchase data.

17. A program causing an information processing apparatus to execute the steps of:
acquiring purchase data regarding a purchase behavior of a user; and
generating recommendation data for the user to purchase a commodity on a basis of the purchase data.
